(19) United States
(12) Patent Application Publication
(10) Pub. No.: US 2003/0098582 A1
(43) Pub. Date: May 29, 2003

(54) Method and device for interconnection of two pipes on a seabed

(76) Inventors: Tore Andersen, Oslo (NO); Atle Rangnes, Asker (NO); Stein Tore Haavimb, Kongsberg (NO); Joren Breda, Nesoya (NO)

Correspondence Address: YOUNG & THOMPSON, 745 SOUTH 23RD STREET 2ND FLOOR, ARLINGTON, VA, 22202

(21) Appl. No.: 10/220,890

(22) PCT Filed: Mar. 7, 2001
(86) PCT No.: PCT/NO01/00098

(30) Foreign Application Priority Data
Mar. 8, 2000 (NO) 2000 1213

(51) Int. Cl. F16L 35/00

(52) U.S. Cl. 285/18; 285/188

(57) ABSTRACT

A method for connection of a first, stationary pipe (21) with a second, movable pipe on a seabed (20). The first pipe (21) is initially enclosed with clearance by a first sleeve (6) of a rigid frame (1). The second pipe is pulled into the frame (1) and enclosed by a second sleeve (7) of the frame (1). From each sleeve (6,7) there protrudes a pipe connection. The pipe connections are interconnected via an interconnecting pipe. Between each sleeve inside the pipe connections and the pipes (21) connected thereto, a gasket is mounted. The gasket is clamped between the sleeves and the pipes by means of jacks. A perforating device finally provides holes through each sleeve (6,7) and the wall of the associated pipe (21), whereby a communication is obtained between the pipes via the pipe connections and the interconnecting pipe. A device for implementing the method and a device for sealing connection of a sleeve with a pipe.

The invention relates to a method for interconnection of a first, stationary pipe and a second movable pipe on a seabed as indicated in the introduction of claim 1.

The invention also relates to a device as indicated in the introduction of claim 3 for implementation of the method.

The invention further relates to a device as indicated in the introduction of claim 10 for sealing interconnection of a pipe and a sleeve.

From the prior art a device is known of the type indicated in claim 3, where the sleeves are separate. The two sleeve parts of each sleeve are pivotably interconnected via a hinge. After pivoting of the second sleeve part towards the first sleeve part for closing the sleeve, opposite free end portions of the respective sleeve parts can be interconnected by means of, e.g. screws and nuts. Even though the sleeves' components are heavy, the work has hitherto been carried out by divers, since until now the depth at which the pipes are located has been relatively moderate.

In the known device, before the first sleeve part is mounted on the pipe, an annuler gasket of an elastomer material is installed between them approximately outside and round an axial extension of the pipe connection, i.e. along the contour of a projection of the pipe connection in its longitudinal direction against the pipe. After the formation of the holes through the first sleeve part and the radially internally located portion of the pipe, the gasket thereby remains arranged outside and along the periphery of these holes, with the result that the space inside the pipe and the pipe connection at the gasket is sealed relative to the space outside the pipe connection and the pipe. It turns out, however, that leaks can occur at such gaskets.

Before interconnection of the pipe connections and thereby the pipes by means of the interconnecting pipe, the pipes are then pulled towards each other to a position wherein the pipe connections are aligned relative to each other. Since the pipes are extremely heavy, difficulties have been encountered in connection with forcing the pipes into such a position.

The object of the invention is to provide a method and devices as indicated in the introduction, whereby the above-mentioned disadvantages of the prior art have at least been reduced.

The characteristics of the method and the devices according to the invention are set forth in the claims.

The invention will now be described in more detail with reference to the drawing which illustrates an embodiment of the devices according to the invention.

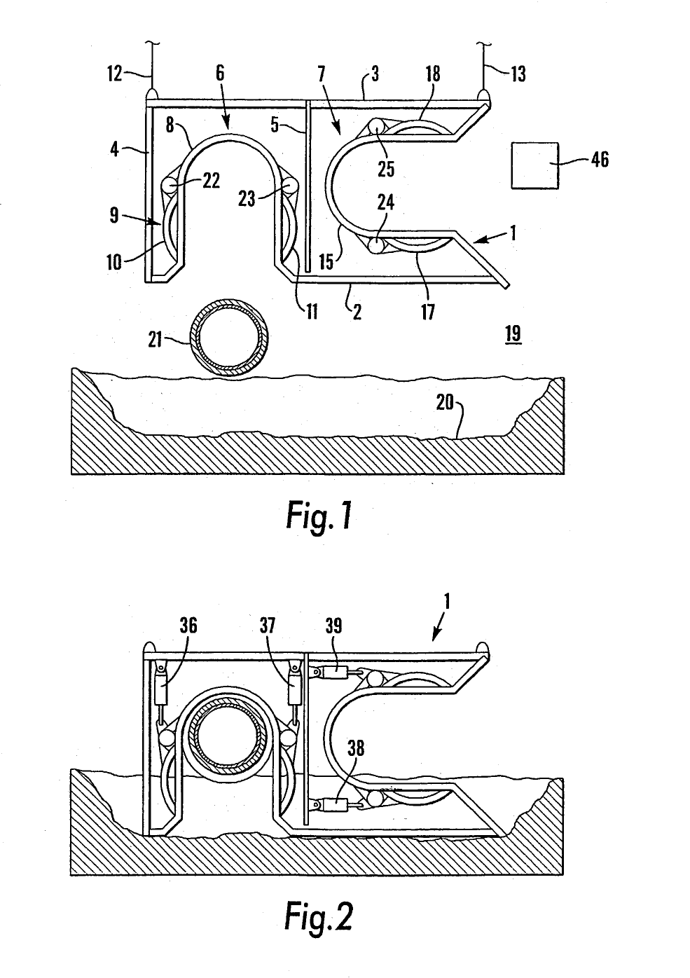

FIG. 1 is a view of a frame which is located above a pipe lying on the seabed, where the pipe is cut off and a first sleeve of the frame is open downwardly.

FIG. 2 is a view of the frame illustrated in FIG. 1, where a first sleeve part of the first sleeve of the frame has been caused to extend close to and along an upper portion of the pipe, and where two flaps of a second sleeve part of the sleeve extend downwards from the first sleeve part.

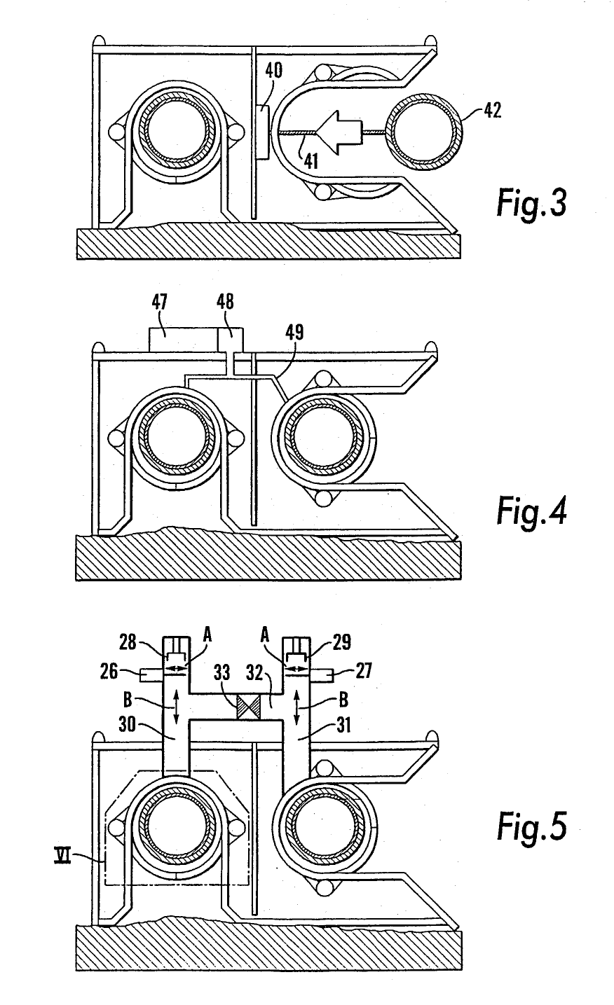

FIG. 3 is a view of the frame illustrated in FIG. 2, where the flaps of the second sleeve part of the first sleeve have been pivoted into a position wherein they extend close to and along a lower portion of the pipe, while a second pipe is located beside a second sleeve of the frame, this second sleeve being open laterally.

FIG. 4 is a view of the frame illustrated in FIG. 3, where a first sleeve part of the second sleeve extends close to an along a first side portion of the second pipe.

FIG. 5 is a view of the frame illustrated in FIG. 4, where two flaps of the second sleeve part of the second sleeve have been pivoted into a position, wherein they extend close to and along an opposite side portion of the second pipe, and a interconnecting pipe extends between pipe connections extending up from each sleeve.

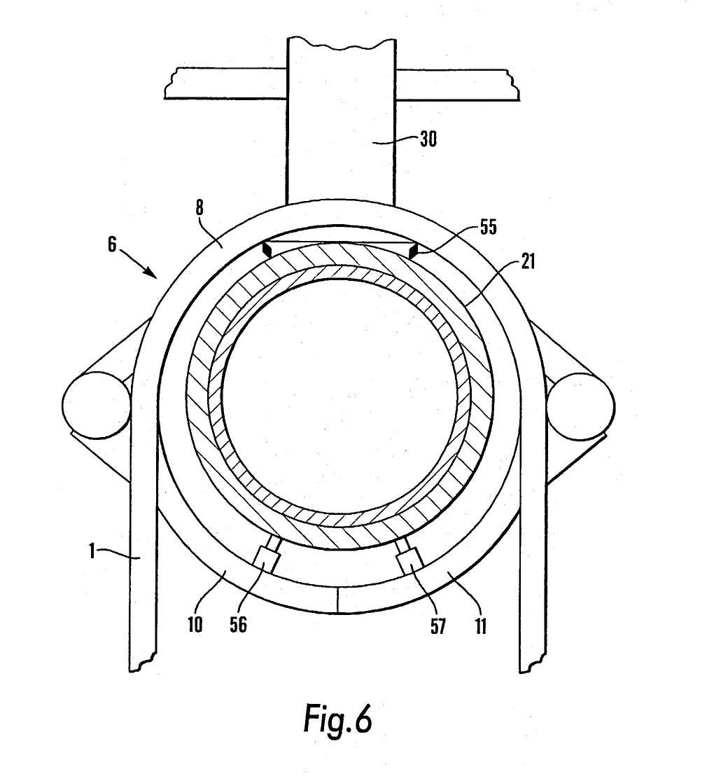

FIG. 6 is an enlarged view of a section VI in FIG. 5.

The term “up” should hereinafter be understood to refer to the direction towards the edge of the drawings facing away from the reader.

As illustrated in FIG. 1 a rigid frame 1 comprises external, horizontal and vertical frame portions 2, 3 and 4, 5 respectively. In the frame 1 there is provided a first sleeve 6 and a second sleeve 7. The first sleeve 6 has an approximately semicircular first sleeve part 8 which is stationary relative to the frame, and linked thereto is a second similarly curved sleeve part 9 which may comprise or be composed of two flaps 10 and 11, each of which may extend over a circular arc of, e.g., 45°. In the same way, the second sleeve 7 has a stationary, curved first sleeve part 15 and a curved second sleeve part 16 linked thereto which may comprise two flaps 17 and 18 which may be formed in the same way as the two flaps 10, 11 of the first sleeve 6. The first sleeve 6 may be opened so that it is open downwardly, while the second sleeve 7 may be opened so that it is open laterally, away from the first sleeve 6.

The frame 1 may be suspended in one or more ropes 12, 13 extending down into the water 19 from, e.g., a platform at the surface of the sea (not shown) to near a seabed 20 and a first pipe 21 (illustrated in cross section), which may rest on a support device (not shown), which in turn is resting on the seabed.

The flaps 10, 11 of the first sleeve 6 are linked with the first sleeve part 8 of the first sleeve 6 via respective hinge pins 22 and 23, and the flaps 17, 18 of the second sleeve 7 are linked with its first sleeve part 15 via respective hinge pins 24, 25. For pivoting the flaps 10, 11, 17, 18 about the hinge pins, respective activating devices may be provided, such as hydraulic jacks 36, 37, 38, 39 (only illustrated in FIG. 2), which are attached on one side to the frame 1 and on the other side to an associated flap 10, 11, 17, 18.

As illustrated only in FIG. 5, from the convex side of the first sleeve parts 8, 15 of the first and the second sleeves 6, 7 there extends a pipe connection 30 and 31 respectively.

In the pipe connections 30, 31 there may be mounted first and second shut-off valves 26 and 27 respectively which may have valve elements which can slide in the pipe connections' transverse direction into or out of the pipe connections 30, 31, as illustrated by the double arrows A, for closing or opening of the pipe connections. Perforating devices 28 and 29 may further be provided for making holes in the first sleeve parts and a pipe 21 located near the concave inside thereof. For example, a perforating tool of these perforating devices may be moved past a valve element of a shut-off valve 26, 27 when it is open, and after the holes have been made, the perforating tool may be withdrawn, as illustrated by a double arrow B, whereupon-the shut-off valve 26, 27 can be brought into a closed position, thereby closing the associated pipe connection 30, 31.

Between the pipe connections 30, 31 there extends an interconnecting pipe 32 wherein there may be mounted a third shut-off valve 33 which initially is closed.

As illustrated in FIG. 6, between the first sleeve part 8 of the first sleeve 6 and the pipe 21 there may be mounted an annular gasket 55 in the extension of the pipe connection 30 against the pipe 21, i.e. round a projection of the pipe connection 30 on the pipe 21.

Furthermore, approximately diametrically above the pipe connection 30, between the pipe 21 and each of the sleeve flaps 10, 11, there are provided respective jacks 56, 57, whereby the sleeve 6 can be forced downwards relative to the pipe 21, thus causing the gasket 55 to be clamped between the upper or first sleeve part 8 and the pipe 21. The gasket 55 thereby provides a seal between the space inside the pipe and in the pipe connection relative to the space outside the pipe and the pipe connection.

The jacks 56, 57 may be of any type, e.g. mechanical or hydraulic, etc.

If the jacks are mechanical, they may be designed in such a manner that they are self-locking, i.e. a movement of components of the jacks may be obtained in one direction by means of an operational device in such a manner that a force is exerted against the pipe 21 and a corresponding reaction force against the sleeve 6, but it is not possible to move the components in the opposite direction merely by removing the operational device. Such jacks can be operated, e.g. by means of a remotely controlled underwater vehicle 46 (FIG. 1), e.g. by an operating element thereof rotating a worm screw of the respective jacks.

If the jacks are hydraulic, e.g. hydraulic cylinders, a similar locking effect can be achieved by using as a hardenable fluid, a pressure fluid supplied to the jacks for operation thereof, where the fluid sets after a defined interval following the operation, forming a block in the cylinder, this block preventing a return movement of the hydraulic cylinders' piston.

As illustrated in FIG. 4, in this case the frame 1 may comprise a reservoir 47 for the hardenable liquid and a device 48 whereby this liquid or material, e.g. a liquid, hardenable resin, can be introduced into the jacks 56, 57 under great pressure via pipes 49. If two components or ingredients are required for production of the hardenable material, these components may, e.g., be stored under pressure in separate containers of the remotely controlled underwater vehicle and transferred via suitable couplings (not shown) to pipes (not shown) in the frame 1, these pipes being connected to the hydraulic cylinders.

In order to ensure a maximum degree of sealing, the area of the gasket 55 facing the upper sleeve part 8 and the area facing the pipe 21 may be tapered or pointed in cross section. These areas may be in the form of a knife-edge. The gasket 55 may then be made of a material, e.g. a metal which is harder than the material whereof the first sleeve part 8 and the pipe 21 are made, thus enabling the above-mentioned areas to penetrate into the first sleeve part 8 and the pipe 21 respectively when the sleeve 6 is pulled down relative to the pipe 21 by means of the jacks 56, 57. The gasket 55 may have shoulders (not shown) which are arranged at a distance from the knife edge, thus causing the gasket to penetrate only to a specified depth in the sleeve and the pipe.

The gasket may be loose and placed at the desired location on the pipe 21 before the sleeve part 8 is placed on the pipe. The gasket 55, however, is preferably attached sealingly to the first sleeve part 8 before the frame 1 is lowered into the water. In this case only the portion of the gasket 55 facing the pipe 21 is made pointed.

Moreover, the jacks 56, 57 may similarly be attached in advance to the respective sleeve flaps 10, 11.

It will be appreciated that in the same way a gasket (not shown) similar to the gasket 55 may also be mounted between the second pipe 42 and the second collar 7. Furthermore, jacks (not shown) may be provided for relative movement of the second pipe 42 and the second collar 7 in order to provide a sealing connection between the collar 7 and the pipe 42 by means of the gasket.

The frame 1 also comprises a winch 40 with a rope 41 (illustrated only in FIG. 3) which can be attached to a second pipe 42 (illustrated in cross section), and whereby this second pipe 42 can be pulled towards the first sleeve part 15 of the second sleeve 7.

FIGS. 2-5 illustrate the process of connecting the frame and the pipes after gaskets 55 have been mounted between them.

FIG. 2 illustrates the relative position of the first pipe 21 and the frame 1 after the frame 1 has been lowered further relative to the position illustrated in FIG. 1, and the frame 1 and the pipe 21 have a correct relative position for inter-connection thereof. The first sleeve part 8 extends hereby with a small clearance round the upper portion of the first pipe 21.

The other sleeve flaps 10, 11 of the first sleeve 6 are then pivoted so that they extend with only a small clearance round an opposite, lower portion of the first pipe 21.

By means of the winch 40 and the rope 41 which are then attached to the second pipe 42 (illustrated in cross section), the second pipe 42 is pulled towards the first sleeve part 15 of the second sleeve 7 until the pipe 42 extends close thereto, whereupon the flaps 17, 18 of the second sleeve part of the second sleeve 7 are pivoted in such a manner that its sleeve parts 15, 17, 18 enclose the second pipe 42 with clearance, as illustrated in FIG. 4.

The hardenable pressure fluid is then introduced into the jacks 56, 57 by means of the introduction device 48 and via the pipe 49 whereby a sealed connection is provided between the pipe connections 30, 31 and the respective pipes.

After the hardenable material has set, the pipes 21, 42 are held securely by the sleeves and the first sleeve parts are sealingly connected to the pipes.

The first and the second shut-off valves 26, 27 are then opened, and by means of the perforating tools of the perforating devices 28, 29, for each sleeve 6, 7 through-going holes are formed through the respective first sleeve parts 8, 15 and the pipes 21, 42. The perforating tools are then withdrawn and the first and the second shut-off valves 26, 27 may be closed, e.g. if the perforating devices have to be removed from the pipe connections 30, 31.

In order to create a communication between the first and the second pipes 21, 42, the third shut-off valve 33 in the interconnecting pipe 32 is opened.

The hydraulic jacks 36-39 for operation of the other sleeve parts 10, 11, 17, 18 and the perforating devices 28, 29 may be operated by a remotely controlled underwater vehicle 46. For this purpose these devices have coupling devices (not shown) such as hydraulic quick couplings, polygonal screw heads, etc. which can be connected to or gripped by complementary or interacting coupling devices of the remotely controlled underwater vehicle 46. There is therefore no longer a need for divers, thus enabling the device according to the invention to be employed at very great depths, where the highly efficient sealing provided by the annular gaskets 55, the jacks 56, 57 and the hardenable material ensure very reliable operation of the device according to the invention.

Even though components of the device according to the invention have been omitted in some of the figures in order to improve their clarity, it will be appreciated that the device comprises such components and that they could have been included in all the figures.

Even though it is stated above that the pipe connections have shut-off valves 26, 27, it will be understood that these may be superfluous if the pipe connections do not require to be opened for removal of the perforating devices after the perforation of the first sleeve parts and the pipes. It will further be understood that the third shut-off valve in the interconnecting pipe between the pipe connections may be superfluous if additional shut-off valves are mounted in the pipe connections.

Even though it is stated above that the frame has a reservoir 47 and a pump 48 together with a device or pipe 49 for the supply of a hardenable material, it will be understood that each sleeve may have, e.g. only a nipple (not shown) which can be connected to a connecting piece of the remotely controlled underwater vehicle 46, which in turn may comprise both the reservoir and the pump. It will thus be appreciated that the device or the pipe 49 is limited to comprising only this nipple.

Even though the other sleeve parts are preferably hinged to the first sleeve parts, it will be understood that the other sleeve parts may be connected to the frame in other ways, e.g. by means of guide arms or the like. In this case too hydraulic jacks, e.g., may be provided for movement of the other sleeve parts relative to the frame.

Even though an inter-connection of two pipes by means of the above-mentioned frame has been described above, it will be appreciated that in order to provide a branch of a pipe, a sleeve 6 and a gasket 55 according to the invention may be employed. A frame may then be superfluous.

It will be understood that if the pipes 21, 42 comprise an external covering layer, e.g. of concrete, this covering layer may be removed before the sleeves are mounted.

1. A method for interconnection of a first, stationary pipe (21) and a second, movable pipe (42) on a seabed (20) by means of a first and a second sleeve (6 and 7 respectively), each of which has a first sleeve part (8 and 15 respectively) and a second sleeve part (10, 11 and 17, 18 respectively), where there project from the first sleeve parts respective pipe connections (30, 31), comprising the steps for the first pipe (21) in connection with the first sleeve (6):
a) placing the inside of the first sleeve part (8, 15) of the sleeve (6, 7) near a first portion of the pipe (21, 42) at a location on the pipe (21, 42) considered in the pipe's (21, 42) longitudinal direction,
b) placing the inside of the second sleeve part (10, 11, 17, 18) near an oppositely located second portion of the pipe (21, 42),
c) interconnecting the two sleeve parts (8, 10, 11, 15, 17, 18) so that they enclose the pipe (21, 42), and
d) sealingly interconnecting a first portion of the first sleeve part (8, 15) located in relation to the pipe (21, 42) radially inside the pipe connection (30, 31) and an adjacent second portion of the pipe (21, 42) in such a manner that this first portion is sealed in relation to the other portion between the sleeve parts (8, 10, 11, 15, 17, 18) and the pipe (21,42),
e) forming a hole in the first sleeve part (8, 15) and the pipe (21) inside the first portion, thus providing communication between the pipe connection (30, 31) and the pipe (21, 42) while maintaining the seal between the first portion and the other portion,
f) for the second pipe (42) in connection with the second, corresponding sleeve (7), carrying out steps corresponding to steps a)-e), and
g) interconnecting the pipe connections (30, 31) and providing a communication between the pipes (21, 42), characterized by the step, by means of a rigid frame (1) comprising both sleeves (6, 7), and an interconnecting pipe (32) arranged between the pipe connections (30, 31), where the first sleeve parts (8, 15) are stationary and the second sleeve parts (10, 11, 17, 18) are movable relative to the frame (1),
h) before step f), pulling the second pipe (42) towards the first sleeve part (15) of the second sleeve (7) until this pipe (42) is located near the inside of the first sleeve part (15).

2. A method according to claim 1, characterized by controlling the steps for the interconnection of the pipes (21, 42) by using a remotely controlled underwater vehicle (46).

3. A device for implementing the method indicated in claim 1, for interconnection of a first, stationary pipe (21) and a second, movable pipe (42) on a seabed (20) by means of a first and a second sleeve (6 and 7 respectively), each of which has a first sleeve part (8 and 15 respectively) and a second sleeve part (10, 11 and 17, 18 respectively), where there project from the first sleeve parts respective pipe connections (30, 31), comprising the steps for the first pipe (21) in connection with the first sleeve (6)
a) placing the inside of the first sleeve part (8, 15) of the sleeve (6, 7) near a first portion of the pipe (21, 42) at a location on the pipe (21, 42) considered in the pipe's (21, 42) longitudinal direction,
b) placing the inside of the second sleeve part (10, 11, 17, 18) near an oppositely located second portion of the pipe (21, 42),
c) interconnecting the two sleeve parts (8, 10, 11, 15, 17, 18) so'that they enclose the pipe (21, 42), and
d) sealingly interconnecting a first portion of the first sleeve part (8, 15) located in relation to the pipe (21, 42) radially inside the pipe connection (30, 31) and an adjacent second portion of the pipe (21, 42) in such a manner that this first portion is sealed in relation to the other portion between the sleeve parts (8, 10, 11, 15, 17, 18) and the pipe (21, 42),
e) forming a hole in the first sleeve part (8, 15) and the pipe (21) inside the first portion, thus providing communication between the pipe connection (30, 31) and the pipe (21, 42) while maintaining the seal between the first portion and the other portion,
f) for the second pipe (42) in connection with the second, corresponding sleeve (7), carrying out steps corresponding to steps a)-e), and
g) interconnecting the pipe connections (30, 31) and providing a communication between the pipes (21, 42), characterized in that the device comprises
a rigid frame (1) supporting both sleeves (6, 7),where the first sleeve parts (8, 15) are stationary and the second sleeve parts (10, 11, 17, 18) are movable relative to the frame, and
the pipe connections (30, 31) are interconnected via an interconnecting pipe (32).

4. A device according to claim 3, characterized in that the frame (1) comprises jacks whereby the second sleeve parts (10, 11, 17, 18) can be caused to enclose the respective pipes (21, 42).

5. A device according to claim 3 or 4, characterized in that the sleeve parts (8, 10, 11, 15, 17, 18) of each sleeve (6, 7) are pivotably interconnected.

6. A device according to one of the claims 3-5, characterized in that each of the second sleeve parts comprises two flaps (10, 11 and 17, 18 respectively), each of which is pivotably connected to the associated, first sleeve parts (8, 15).

7. A device according to one of the claims 3-6, characterized in that the first sleeve part (8) of the first sleeve (6) and the first sleeve part (15) of the second sleeve (7) are concave in directions extending perpendicularly to each other.

8. A device according to one of the claims 3-7, characterized in that the frame (1) comprises a winch (40) for pulling the second pipe (42) towards the first sleeve part (15) of the second sleeve (7).

9. A device according to one of the claims 3-8, characterized in that it has coupling devices whereby its operation can be controlled by a remotely controlled underwater vehicle (46).
